(19) United States
(12) Patent Application Publication
(10) Pub. No.: US 2005/0256254 A1
(43) Pub. Date: Nov. 17, 2005

(54) Pressure-sensitive adhesive material for film strips that are contact adhesive on one or both sides, and method for the production thereof

(75) Inventors: Bernd Luhmann, Norderstedt (DE); Manfred Spies, Bad Bramstedt (DE); Andreas Junghans, Hamburg (DE); Thorsten Krawinkel, Hamburg (DE); Christian Ring, Hamburg (DE); Kerstin Franck, Hamburg (DE)

Correspondence Address: NORRIS, MCLAUGHLIN & MARCUS, P.A., 875 THIRD AVE, 18TH FLOOR, NEW YORK, NY, 10022, US

(73) Assignee: tesa Aktiengesellschaft, Hamburg (DE)

(21) Appl. No.: 10/516,980

(22) PCT Filed: May 8, 2003
(86) PCT No.: PCT/EP03/04825

§ 371 Date: Jul. 14, 2005

(30) Foreign Application Priority Data
Jun. 5, 2002 (DE) 102 24 842.7

(51) Int. Cl. C08K 3/00

(52) U.S. Cl. 524/555; 524/556

(57) ABSTRACT

A pressure sensitive adhesive for single-sided or double-sided adhesive sheet strips which can be redetached without residue or destruction by extensive stretching in the plane of the bond, composed of a mixture comprising a block copolymer and a tackifier, characterized in that at least one compound which is swellable in H₂O is incorporated into the mixture.

The invention relates to a pressure sensitive adhesive (PSA) for single- and double-sided adhesive sheet strips which can be redetached without residue or destruction by extensive stretching in the plane of the bond, composed of a mixture comprising a block copolymer and a tackifier.

The invention further relates to a use of the pressure sensitive adhesive.

Highly elastically or plastically stretchable self-adhesive tapes which can be redetached without residue or destruction by extensive stretching in the plane of the bond are known from, for example, U.S. Pat. No. 4,024,312, DE 3331 016 C2, WO 92/01132 A1, WO 92/11333 A1, DE 42 22 849 A1, WO 95/06691 A1, DE 195 31 696 A1, DE 196 26 870 A1, DE 196 49 727 A1, DE 196 49 728 A1, DE 196 49 729 A1, DE 197 08 364 A1, DE 197 20 145 A1, DE 198 20 854 A1, WO 99/37729 A1 and DE 100 03 318 A1 and are referred to inter alia below as strippable self-adhesive tapes.

Strippable self-adhesive tapes of this kind are frequently used in the form of single- or double-sided adhesive sheet strips, which preferably have a nonadhesive grip region from which the detachment operation is initiated.

Particular applications of such self-adhesive tapes can be found in DE 42 33 872 A1, DE 195 11 288 A1, U.S. Pat. No. 5,507,464 A, U.S. Pat. No. 5,672,402 A and WO 94/21157 A1, with specific embodiments being described in, for example, DE 44 28 587 A1, DE 44 31 914 A1, WO 97/07172 A1, DE 196 27 400 A1, WO 98/03601 A1 and DE 196 49 636 A1, DE 197 20 526 A1, DE 197 23 177 A1, DE 297 23 198 A1, DE 197 26 375 A1, DE 197 56 084 A1, DE 197 56 816 A1, DE 198 42 864 A1, DE 198 42 865 A1, WO 99/31193 A1, WO 99/37729 A1 and WO 99/63018 A1.

The fields of use of aforementioned strippable adhesive sheet strips include in particular the residueless and nondestructive redetachable fixing of light to moderately heavy articles in the home, workplace, and office segments. In these applications they replace conventional fastening means, such as, for example, drawing pins, roundhead needles, thumbtacks, nails, screws, conventional self-adhesive tapes, and liquid adhesives. Key to the successful use of the adhesive sheet strips is not only the possibility of residueless and nondestructive redetachment of bonded articles but also their quick and easy bonding and also their secure hold for the envisaged period of bonding. It should be borne in mind in particular here that the adhesive strips must function on a large number of substrates in order to be able to serve as a universal fixing in the home, workplace, and office segments.

Despite the fact that the patent literature cited above describes a broad range of PSAs for use in strippable self-adhesive tapes, commercial products currently on the market (for example, tesa® Powerstrips® from tesa AG, 3M Command® Adhesive Strips from 3M, and Plastofix® Formule Force 1000 Adhesive Strips from Plasto S.A.) all have PSAs based on styrene block copolymers with unsaturated polydiene blocks in the elastomer block.

Typically use is made of linear or radial block copolymers based on polystyrene blocks and polybutadiene blocks and/or polyisoprene blocks: i.e., for example, radial styrene-butadiene (SB)ₙ and/or linear styrene-butadiene-styrene (SBS) and/or linear styrene-isoprene-styrene (SIS) block copolymers. Advantages of aforementioned styrene block copolymer based PSAs for use in strippable self-adhesive tapes are, for example, the very high bond strengths which can be achieved with them (owing, inter alia, to the simultaneous realization of very high cohesion and very high adhesive forces), pronounced reduction in tack during stretching detachment (which greatly facilitates, if not indeed being a precondition for, the operation of detachment), and a very high tensile strength, which is essential in particular for an operation of detachment with no tearing.

The products available on the market, all of which utilize PSAs based on styrene block copolymers, exhibit weaknesses in bond strength under the influence of atmospheric humidity or water. This behavior is particularly pronounced when bonds are made to hydrophilic substrates such as glass or ceramic. Particularly in the case of moisture exposure shortly after the bonding of moderately heavy articles, failure of the PSA strips is a frequent occurrence. The holding power under the influence of moisture is reduced in particular in those PSA strips which comprise nonpolar tackifier resins such as hydrocarbon resins or polyterpene resins.

In the case of products which include an intermediate foam carrier with adhesive applied to both sides thereof, the reduction in bond strength under moisture exposure is more strongly pronounced than in the case of adhesive strips composed of just one layer of adhesive.

Failure of the bond occurs in the case of a simple peeling load and particularly in the case of a tipping/shearing load (where a torque is active, as in the case, for example, of bonding of a hook with a particular lever on which something is hung) to a much greater extent than in the case of a plain shearing load.

It is an object of the present invention to present a pressure sensitive adhesive for a single- or double-sided adhesive sheet strip which can be redetached without residue or destruction even from sensitive substrates by extensive stretching essentially parallel to the plane of the bond and which possesses good bond strengths even on hydrophilic substrates such as glass or ceramic and even at elevated atmospheric humidity.

This object is achieved by means of a pressure sensitive adhesive as specified in the main claim. Advantageous developments of the subject matter of the invention are found in the subclaims.

The invention accordingly provides a pressure sensitive adhesive composed of a mixture comprising a block copolymer and a tackifier, wherein at least one compound which is swellable in H₂O has been incorporated into the mixture.

With a large number of pressure sensitive adhesives the bonding performance subsides considerably under the influence of high atmospheric humidity or water. Not only is it the case that damp or wet adhesive strips adhere much less well or even not at all, or that they are difficult to bond to wet substrates, but also existing bonds of an adhesive tape on a substrate can be impaired in their load-bearing capacity, or even fail completely, under the influence of humidity or water. This phenomenon is particularly pronounced in the case of hydrophilic substrates such as glass or ceramic products such as tiles. Ceramic tiles in particular are frequently found in bathrooms or kitchens, where for short periods the atmospheric humidity can rise very greatly. Hydrophilic substrates possess the property of often having a very thin layer of adsorbed water on the surface, which can only be removed at very high temperatures. As a result of this thin water layer it is very easy for humidity or water to be picked up by glass. Owing to the molecular structure of the glass it is even capable of taking water into the glass itself and not only of absorbing it on the surface. Similar considerations apply to ceramic products as well.

If, then, an adhesive tape is bonded to ceramic products or glass, a thin water layer remains between the adhesive tape and the glass. This layer is so thin that the bonding properties of the adhesive tape are unaffected: the bond between adhesive tape and glass can be very strong, similar to that between steel and the same adhesive tape.

If moisture in the form of high atmospheric humidity or water acts on the bond, the water layer between glass and adhesive strip can pick up further water, which causes the layer to grow. Water can also diffuse through the glass to the bond area. Consequently the bond performance is reduced to such an extent that it can lead to the failure of the bond.

It is standard practice to use very soft adhesives which are able to seal all of the pores in the glass, so that the water is no longer able to diffuse into the intermediate layer. This path is taken, for example, in the bonding of laminated glass sheets, where an isobutyl rubber adhesive is employed (according to Skeist, “Handbook of Adhesives”, 2nd edition, 1977).

For strippable systems as described above this path is not possible if the adhesive strips are to offer a very high bond strength and are also to be removable again without destruction by pulling in the plane of the bond. These two properties are only achievable if the adhesive possesses a high cohesion and high tensile strength; in other words, the adhesive must be formulated to be relatively hard. As a consequence it is not possible for the adhesives described to go so well onto the glass or the ceramic that all of the pores in the glass are sealed. Water is therefore able to penetrate into the space in between and lead to the failure of the bond. This effect is especially pronounced when adhesive strips are used which have an intermediate foam carrier. In this case water or moisture penetrate very much more rapidly than in the case of adhesive strips which are composed only of said adhesive without the use of such an intermediate carrier.

The compound which is swellable in H₂O retards penetration of moisture into the interface between PSA strip and substrate. A compound of this kind which is swellable in H₂O may be, for example, a hydrogel. Hydrogels are water-containing gels based on polymers which are hydrophilic, and yet water-insoluble, which are present as three-dimensioned networks. The polymers swell up in water until they reach the same volume by weight, while maintaining the shape.

In one preferred embodiment of the invention the compound which can swell in H₂O is a superabsorbent. Superabsorbents are crosslinked, or partially crosslinked, hydrophilic polymers which bind up to several times their own weight of liquid and are able to hold on to it even under the influence of an external force. Superabsorbents form a gel-like consistency by absorbing water or aqueous solution.

The superabsorbent is preferably present in a range between 0.5 to 20% by weight and more preferably between 2 to 8% by weight, based on the pressure sensitive adhesive. The addition of small amounts of superabsorbents has the advantage that the mechanical and performance properties of the PSA strips on dry substrates are not altered in such a way as to restrict the actual purpose of use.

A single superabsorbent or a mixture of two or more superabsorbents is preferably incorporated into the mixture.

These superabsorbents can preferably be used on different chemical bases, such as, for example, sodium salts of crosslinked polyacrylic acid (for example Favor® from Stockhausen, Sanwet® from Hoechst and Sanyo, Drytech® from Dow Chemicals, Aqualic from BASF or, for example, Norsocryl from Atochem), starch-modified, crosslinked polyacrylic acid (also available under the name Sanwet® from Hoechst and Sanyo), crosslinked polyacrylamides, crosslinked polysulfonic acid or carboxy-methylcellulose. The superabsorbents are able to absorb water, and swell up in the process. Because of their crosslinked structure, they cannot be dissolved in organic solvents and nor can they be melted by heating. Thus the superabsorbents do not change their chemical structure during incorporation into the adhesive, be it by removal from solvents or by extrusion from the melt. In adhesives, superabsorbents behave like polymeric fillers. Thus, in a low proportion, the superabsorbents also have no influence on the mechanical properties of PSA strips formed with the PSA. The performance properties in the dry likewise show no influence when a superabsorbent is added.

At a concentration of just 0.5% by weight of superabsorbent, based on the overall adhesive, a considerable reduction is obtained in the sensitivity to moisture. The amount of superabsorbent required for sufficient bond performance depends on the nature of the superabsorbent, on the hardness of the adhesive, on the performance capability to be attained, and also on the substrate, to mention but a few of the influences. When the superabsorbents of the present invention are used, the particle size is also to be harmonized with the design of the product. In many cases, by grinding operations, it is possible to reach particle sizes of much smaller than 1 mm, so that use in pressure sensitive adhesive strips, which normally possess a PSA film thickness of 1 mm, is possible.

A use of superabsorbents in sealants for adhesive cable bonds which protect against moisture by virtue of the superabsorbents' swellability is described in DE 196 52 762 A1. Furthermore, DE 44 34 171 A1 describes the use of superabsorbents in hygiene products. The adhesive in those applications is coated with the absorbents. The superabsorbents in the present invention, however, are incorporated into the adhesive and not coated onto it.

The mixture preferably comprises at least one additive. In order to stabilize the PSAs it is usual to add antioxidants. Additives can be primary or secondary antioxidants; in particular, as primary antioxidants, sterically hindered phenols and, as secondary antioxidants, phosphites or thiols are employed. C-radical scavengers can also be added.

As an additive, however, it is also possible to use light stabilizers, such as UV absorbers or sterically hindered amines, for example. It is likewise possible to add in antiozonants, metal deactivators, processing auxiliaries or endblock-reinforcing resins.

Further possible additives include plasticizers. Plasticizers used can be liquid resins, plasticizer oils or low molecular mass liquid polymers, which comprise a low molecular mass polyisobutylene having a molar mass <1500 g/mol or a liquid EPDM (ethylene/propylene-diene terpolymer) grade with a maximum proportion of 20% by weight.

Fillers, such as silica, glass (ground or in the form of beads), alumina, zinc oxide, calcium carbonate, titanium dioxide or carbon black, to name but a few, and also color pigments and dyes, and optical brighteners, can likewise be used.

The invention is further achieved by a use of the pressure sensitive adhesive as claimed in one of the preceding claims, for producing a single-sided and/or double-sided adhesive sheet strip.

Pressure sensitive adhesives used include those based on block copolymers containing polymer blocks formed from vinylaromatics (A blocks), such as styrene, for example, and those formed by polymerization of 1,3-dienes (B blocks), such as butadiene and isoprene, for example. Resultant block copolymers can contain identical or different D blocks, which may be partly, selectively or fully hydrogenated. Block copolymers can have a linear A-B-A structure. It is likewise possible to use block copolymers of radial design and also star-shaped and linear multiblock copolymers. A-B diblock copolymers may be present as a further component. Block copolymers of vinylaromatics and isobutylene are likewise suitable for use. All of the aforementioned polymers can be utilized alone or in a mixture with one another.

Instead of polystyrene blocks it is also possible to utilize polymer blocks based on other aromatics-containing homopolymers and copolymers (C-8 to C-12 aromatics) having glass transition temperatures of > about 75° C., such as aromatics blocks containing α-methylstyrene, for example. Also suitable for use are polymer blocks based on (meth)acrylate homopolymers and (meth)acrylate copolymers having glass transition temperatures of >75° C. In this context it is possible to employ not only block copolymers whose hard blocks are exclusively those based on (meth)acrylate polymers but also block copolymers which utilize both polyaromatics blocks, such as polystyrene blocks, and poly(meth)acrylate blocks.

Instead of styrene-butadiene block copolymers and styrene-isoprene block copolymers and their hydrogenation products, viz. styrene-ethylene/butylene block copolymers and styrene-ethylene/propylene block copolymers, it is likewise possible to utilize block copolymers and their hydrogenation products which utilize further, polydiene-containing elastomer blocks, such as, for example, copolymers of two or more different 1,3-dienes. Also possible for use are functionalized block copolymers wherein the block copolymer is a maleic anhydride-modified or silane-modified styrene block copolymer.

Typical use concentrations for the block copolymer are situated in the range between 20% and 70% by weight, in particular in the range between 30% and 60% by weight, and in the range from 35% to 55% by weight.

As further polymers it is possible to use those based on straight hydrocarbons, examples being unsaturated polydienes, such as natural or synthetic polyisoprene or polybutadiene, chemically substantially saturated elastomers, such as a saturated ethylene-propylene copolymer, an α-olefin copolymer, a polyisobutylene, a butyl rubber, an ethylene-propylene rubber, or a chemically functionalized hydrocarbon, such as a polyolefin containing halogen, acrylate or vinyl ether, which are able to replace up to about 100 phr (parts per hundred parts of resin) of the vinylaromatics-containing block copolymers, based on the styrene block copolymer.

The pressure sensitive adhesive can be crosslinked by chemical means, especially radiation-chemical means, for example by UV radiation, γ-radiation or by bombardment with fast electrons.

Pressure sensitive adhesives of the present invention are optionally those whose pressure sensitive adhesion is brought about only by thermal activation or solvent activation.

In addition to those described above based on vinylaromatics-containing block copolymers, suitable pressure sensitive adhesives include all those which have an extension, cohesion, and tensile strength sufficient for the detachment operation. PSAs of this kind can be used alone or in combination with those based on vinylaromatics-containing block copolymers.

The tackifier is a tackifying resin which is compatible with the elastomer block of the styrene block copolymers. Suitable tackifying resins include preferably nonhydrogenated, partly hydrogenated or fully hydrogenated resins based on rosin or on rosin derivatives, hydrogenated polymers of dicyclopentadiene, nonhydrogenated, partly, selectively or fully hydrogenated hydrocarbon resins based on C-5, C-5/C-9 or C-9 monomer streams, polyterpene resins based on α-pinene and/or β-pinene and/or δ-limonene, a hydrogenated polymer of pure C-8 or C-9 aromatics. Aforementioned tackifying resins can be used either alone or in a mixture.

Pressure sensitive adhesives of the invention can be used for single-layer self-adhesive tapes redetachable without residue or destruction by extensive stretching (in accordance for example with DE 33 31 016 C2, DE 42 22 849 C1 or WO 98/03601 A1) and also for multilayer self-adhesive tapes with or without an intermediate foam carrier (in accordance for example with DE 197 08 366 A1, DE 198 20 858 A1, WO 92/11333 A1, DE 196 49 727 A1, DE 196 49 728 A1, DE 196 49 729 A1, DE 197 20 145 A1, U.S. Pat. No. 5,516,581 A or WO 95/06691 A1). Where they are used in multilayer self-adhesive tapes in accordance with DE 197 08 366 A1 the PSAs form the outer layers of the adhesive strips. Adhesive strips can be shaped in accordance with DE 44 28 587 C2 and U.S. Pat. No. 5,925,459 A and/or modified in accordance with DE 44 31 914 C2. The pressure sensitive adhesive can likewise be utilized in products in accordance with DE 43 39 604 C2.

Suitable intermediate carriers comprise, for example, foam carrier materials (intermediate foam carriers), especially homopolymers and copolymers of ethylene, especially polyethylenes of low and very low density (LDPE, LLDPE, VLDPE), ethylene-vinyl acetate copolymers, and mixtures of aforementioned polymers. Further possible polymers include, inter alia: polyvinyl acetates, polypropylenes, polyurethanes based on aromatic and aliphatic diisocyanates, polystyrene, impact-modified polystyrenes, PVC, acrylate copolymers. Foams can be employed in crosslinked or noncrosslinked form.

The thicknesses of the foams employed are in particular between 175 μm and 10 mm, preferably between 250 μm and 5 mm, more preferably between 350 μm and 3 mm. Densities are from 20 to 400 kg/m³, preferably from 25 to 250 kg/m³, more preferably from 25 to 150 kg/m³. The foam structure can be a closed-cell, open-cell or mixed-cell structure. Both skinned and nonskinned foams of integral or nonintegral structure can be utilized. In accordance with the invention it is likewise possible to use laminates of two or more foams.

In order to achieve sufficient anchoring of the PSAs used on the foams they are advantageously subjected to a pressure pretreatment during the production process and/or prior to their coating with PSA. Suitable pretreatment methods include, inter alia, fluorine pretreatment, corona pretreatment, plasma pretreatment and flame pretreatment, the latter in particular by means of electrically polarized flames. Pretreatment methods can be employed alone or in combination. In the case of skinned foams and integral foams the foam can be primed in order to improve further the anchoring of the adhesive.

Open-cell and mixed-cell foams can be subjected to impregnation. As an option it is possible to integrate between foam and PSAs a barrier layer in order to reduce the migration of migratable materials between PSAs and foam.

### Preparation of the PSAs

The preparation and processing of the pressure sensitive adhesives can take place from solution and from the melt. It has proven advantageous to manufacture the adhesive from the melt. For the latter case, suitable production operations include both batch processes and continuous processes. Particularly appropriate here is the continuous manufacture of the pressure sensitive adhesive by means of an extruder.

### Converting

Typical converted forms of the self-adhesive tapes utilizing the PSA of the invention are adhesive tape rolls and adhesive strips, such as are obtained in the form of diecuts, for example. Diecuts optionally include a nonadhesive grip tab region starting from which the detachment operation can be performed.

Single-sided self-adhesive tapes can be obtained here, for example, by neutralizing one side of aforementioned double-sided self-adhesive tapes or self-adhesive strips.

In the text below the invention is explained in more detail with reference to examples, without wishing thereby to restrict the invention in any form whatsoever.

As described above, PSA strips consisting of the following constituents are produced:

### EXAMPLE 1

| | | | |
|---|---|---|---|
| 100 | parts | Kraton D 1165 | SIS with 30% block polystyrene |
| | | | content from Kraton Polymers |
| 100 | parts | Wingtack 95 | HC resin having a softening |
| | | | point of 98° C. from Goodyear |
| 0.5 | part | Irganox 1010 | Aging inhibitor from Ciba-Geigy |
| 5 | parts | Favor T ® | Superabsorbent based on the |
| | | | sodium salt of crosslinked |
| | | | polyacrylic acid from |
| | | | Stockhausen |

### COMPARATIVE EXAMPLE C1

| | | | |
|---|---|---|---|
| 100 | parts | Kraton D 1165 | SIS with 30% block polystyrene |
| | | | content from Kraton Polymers |
| 100 | parts | Wingtack 95 | HC resin having a softening |
| | | | point of 98° C. from Goodyear |
| 0.5 | part | Irganox 1010 | Aging inhibitor from Ciba-Geigy |

### EXAMPLE 2

| | | | |
|---|---|---|---|
| 100 | parts | Vector 8508 | SBS with 30% block polystyrene |
| | | | content from Dexco |
| 100 | parts | Piccolyte A 115 | α-Pinene resin having a |
| | | | softening point of 115° C. |
| | | | from Hercules |
| 0.5 | part | Irganox 1010 | Aging inhibitor from Ciba-Geigy |
| 5 | parts | Sanfresh ST- | Superabsorbent based on the |
| | | 100MPS | sodium salt of crosslinked |
| | | | starch-modified polyacrylic |
| | | | acid from Sanyo |

### COMPARATIVE EXAMPLE C2

| | | | |
|---|---|---|---|
| 100 | parts | Vector 8508 | SBS with 30% block polystyrene |
| | | | content from Dexco |
| 100 | parts | Piccolyte A 115 | α-Pinene resin having a |
| | | | softening point of 115° C. |
| | | | from Hercules |
| 0.5 | part | Irganox 1010 | Aging inhibitor from Ciba-Geigy |

### EXAMPLE 3

| | | | |
|---|---|---|---|
| 60 | parts | Kraton D 1165 | SIS with 30% block polystyrene |
| | | | content from Kraton Polymers |
| 40 | parts | Vector 8505 | SBS with 30% block polystyrene |
| | | | content from Dexco |
| 100 | parts | Foral 105 ® | Hydrogenated rosin having a |
| | | | softening point of 101° C. |
| | | | from Hercules |
| 0.5 | part | Irganox 1076 | Aging inhibitor from Ciba-Geigy |
| 5 | parts | Favor T ® | Superabsorbent based on the |
| | | | sodium salt of crosslinked |
| | | | polyacrylic acid from |
| | | | Stockhausen |

### COMPARATIVE EXAMPLE C3

| | | | |
|---|---|---|---|
| 60 | parts | Kraton D 1165 | SIS with 30% block polystyrene |
| | | | content from Kraton Polymers |
| 40 | parts | Vector 8505 | SBS with 30% block polystyrene |
| | | | content from Dexco |
| 100 | parts | Foral 105 ® | Hydrogenated rosin having a |
| | | | softening point of 101° C. |
| | | | from Hercules |
| 0.5 | part | Irganox 1076 | Aging inhibitor from Ciba-Geigy |

### EXAMPLE 4

| | | | |
|---|---|---|---|
| 100 | parts | Kraton D 1165 | SIS with 30% block polystyrene |
| | | | content from Kraton Polymers |
| 100 | parts | Piccolyte A 125 | α-Pinene resin having a |
| | | | softening point of 125° C. |
| | | | from Hercules |
| 5 | parts | Wingtack 10 | Liquid HC resin from Goodyear |
| 0.5 | part | Irganox 1076 | Aging inhibitor from Ciba-Geigy |
| 5 | parts | Favor T ® | Superabsorbent based on the |
| | | | sodium salt of crosslinked |
| | | | polyacrylic acid from |
| | | | Stockhausen |

### COMPARATIVE EXAMPLE C4

| | | | |
|---|---|---|---|
| 100 | parts | Kraton D 1165 | SIS with 30% block polystyrene |
| | | | content from Kraton Polymers |
| 100 | parts | Piccolyte A 125 | α-Pinene resin having a |
| | | | softening point of 125° C. |
| | | | from Hercules |
| 10 | parts | Wingtack 10 | Liquid HC resin from Goodyear |
| 0.5 | part | Irganox 1076 | Aging inhibitor from Ciba-Geigy |

### EXAMPLE 5

| | | | |
|---|---|---|---|
| 100 | parts | Kraton D 1107 | SIS with 15% block polystyrene |
| | | | content from Kraton Polymers |
| 100 | parts | Escorez 5600 ® | Hydrogenated HC resin having a |
| | | | softening point of 103° C. |
| | | | from Exxon |
| 0.5 | part | Irganox 1076 | Aging inhibitor from Ciba-Geigy |
| 5 | parts | Sanfresh ST- | Absorbent based on the sodium |
| | | 500MPS | salt of crosslinked polyacrylic |
| | | | acid from Sanyo |

### COMPARATIVE EXAMPLE C5

| | | | |
|---|---|---|---|
| 100 | parts | Kraton D 1107 | SIS with 15% block polystyrene |
| | | | content from Kraton Polymers |
| 100 | parts | Escorez 5600 ® | Hydrogenated HC resin having a |
| | | | softening point of 103° C. |
| | | | from Exxon |
| 0.5 | part | Irganox 1076 | Aging inhibitor from Ciba-Geigy |

### EXAMPLE 6

| | | | |
|---|---|---|---|
| 50 | parts | Kraton D 1107 | SIS with 15% block polystyrene |
| | | | content from Kraton Polymers |
| 50 | parts | Kraton D 1101 | SBS with 30% block polystyrene |
| | | | content from Kraton Polymers |
| 100 | parts | Foral 105 ® | Hydrogenated rosin having a |
| | | | softening point of 101° C. |
| | | | from Hercules |
| 0.5 | part | Irganox 1076 | Aging inhibitor from Ciba-Geigy |
| 5 | parts | Sanfresh ST- | Superabsorbent based on the |
| | | 500MPS | sodium salt of crosslinked |
| | | | polyacrylic acid from Sanyo |

### COMPARATIVE EXAMPLE C6

| | | | |
|---|---|---|---|
| 50 | parts | Kraton D 1107 | SIS with 15% block polystyrene |
| | | | content from Kraton Polymers |
| 50 | parts | Kraton D 1101 | SBS with 30% block polystyrene |
| | | | content from Kraton Polymers |
| 100 | parts | Foral 105 ® | Hydrogenated rosin having a |
| | | | softening point of 101° C. |
| | | | from Hercules |
| 0.5 | part | Irganox 1076 | Aging inhibitor from Ciba-Geigy |

### EXAMPLE 7

| | | | |
|---|---|---|---|
| 100 | parts | Kraton D 1165 | SIS with 30% block polystyrene |
| | | | content from Kraton Polymers |
| 100 | parts | Piccolyte A 115 | α-Pinene resin having a |
| | | | softening point of 115° C. |
| | | | from Hercules |
| 5 | parts | Ondina G 41 ® | Aliphatic white oil from Shell |
| 0.5 | part | Irganox 1076 | Aging inhibitor from Ciba-Geigy |
| 5 | parts | Favor T ® | Superabsorbent based on the |
| | | | sodium salt of crosslinked |
| | | | polyacrylic acid from |
| | | | Stockhausen |

### EXAMPLE 8

| | | | |
|---|---|---|---|
| 100 | parts | Kraton D 1165 | SIS with 30% block polystyrene |
| | | | content from Kraton Polymers |
| 100 | parts | Piccolyte A 115 | α-Pinene resin having a |
| | | | softening point of 115° C. |
| | | | from Hercules |
| 10 | parts | Ondina G 41 ® | Aliphatic white oil from Shell |
| 0.5 | part | Irganox 1076 | Aging inhibitor from Ciba-Geigy |
| 5 | parts | Favor T ® | Superabsorbent based on the |
| | | | sodium salt of crosslinked |
| | | | polyacrylic acid from |
| | | | Stockhausen |

### EXAMPLE 9

| | | | |
|---|---|---|---|
| 100 | parts | Kraton D 1165 | SIS with 30% block polystyrene |
| | | | content from Kraton Polymers |
| 100 | parts | Piccolyte A 115 | α-Pinene resin having a |
| | | | softening point of 115° C. |
| | | | from Hercules |
| 20 | parts | Ondina G 41 ® | Aliphatic white oil from Shell |
| 0.5 | part | Irganox 1076 | Aging inhibitor from Ciba-Geigy |
| 5 | parts | Favor T ® | Superabsorbent based on the |
| | | | sodium salt of crosslinked |
| | | | polyacrylic acid from |
| | | | Stockhausen |

### COMPARATIVE EXAMPLE C7

| | | | |
|---|---|---|---|
| 100 | parts | Kraton D 1165 | SIS with 30% block polystyrene |
| | | | content from Kraton Polymers |
| 100 | parts | Piccolyte A 115 | α-Pinene resin having a |
| | | | softening point of 115° C. |
| | | | from Hercules |
| 5 | parts | Ondina G 41 ® | Aliphatic white oil from Shell |
| 0.5 | part | Irganox 1076 | Aging inhibitor from Ciba-Geigy |

TABLE 1
Mechanical and performance data

| | Tensile | Stripping | | Tip-shear |
|---|---|---|---|---|
| | strength | tension | Peel rate | stability time |
| Example | in MPa | in MPa | in mm/24 h | in days |
| 1 | 10.7 | 1.9 | 26 | 19 |
| C1 | 10.4 | 1.7 | 23 | 18 |
| 2 | 13.0 | 2.2 | 12 | >60 |
| C2 | 13.3 | 2.1 | 11 | >60 |
| 3 | 12.5 | 1.8 | 16 | 28 |
| C3 | 12.1 | 1.8 | 18 | 31 |
| 4 | 11.6 | 2.2 | 16 | >60 |
| C4 | 11.8 | 2.0 | 14 | >60 |
| 5 | 9.7 | 1.3 | 7 | 14 |
| C5 | 9.5 | 1.2 | 9 | 18 |
| 6 | 10.9 | 1.6 | 6 | 21 |
| C6 | 11.2 | 1.5 | 5 | 18 |
| 7 | 12.2 | 1.5 | 12 | 42 |
| 8 | 12.4 | 1.7 | 16 | 45 |
| 9 | 11.6 | 1.9 | 20 | 34 |
| C7 | 12.4 | 1.4 | 15 | 51 |

Table 1 mechanical and performance data for the examples described above. As can be seen from the values measured for the comparative examples the superabsorbent has no influence on the mechanical properties or on the performance properties in adhesive bonds under dry conditions. Only at proportions of above 10 phr, based on the block copolymer, is it possible to perceive increased stripping forces, but they are not considered disadvantageous. 20 parts of superabsorbent, based on the block copolymer, have small effects on the bonding performance, since there is probably a lot of filler at the surface.

TABLE 2
Bond performances under moisture exposure

| | Peel rate in | Tip-shear stability |
|---|---|---|
| | mm/24 h under | time in days |
| Example | moisture | under moisture |
| 1 | 25 | 17 |
| C1 | >40 | <1 |
| 2 | 14 | >30 |
| C2 | >40 | <1 |
| 3 | 9 | >30 |
| C3 | 32 | 5 |
| 4 | 27 | >30 |
| C4 | >40 | <1 |
| 5 | 20 | 9 |
| C5 | >40 | <1 |
| 6 | 5 | 14 |
| C6 | 21 | 3 |
| 7 | 18 | >30 |
| 8 | 12 | >30 |
| 9 | 23 | >30 |
| C7 | >40 | <1 |

Table 2 shows bond performances under exposure to moisture conditions. Through the addition of a superabsorbent the bond performances under the influence of moisture on hydrophilic substrataes have been significantly improved. Even small amounts are enough to obtain the desired effect.

The mechanical and performance data were determined as follows:

### Tensile Capacity and Maximum Elongation

The tensile capacity and maximum elongation were measured in a method based on DIN 53504 using dumbbells of size S3 at a separation rate of 300 mm per minute.

### Detachment Force

The detachment force (stripping force or stripping stress) was determined using an adhesive sheet measuring 50 mm long×20 mm wide with a nonadhesive grip tab region at the top end. The adhesive sheet was bonded between two steel plates, arranged congruently with one another and measuring 50 mm×30 mm, using an applied pressure of 50 newtons in each case. At their bottom end the steel plates each have a bore to accommodate an S-shaped steel hook. The lower end of the steel hook carries a further steel plate which allows the test arrangement to be fixed in the lower clamping jaw of a tensile testing machine for the purpose of measurement. The adhesive bonds are stored at +40° C. for a duration of 24 hours. After reconditioning to room temperature the adhesive sheet strip is detached with a pulling speed of 1000 mm per minute parallel to the bond plane and without contact with the edge regions of the two steel plates. During this procedure the required detachment force is measured, in newtons (N). The figure reported is the average value of the stripping stress values (in N per mm²), measured in the range in which the adhesive strip has undergone detachment from the steel substrates over a bonding length of between 10 mm and 40 mm.

### Peel Strength

For the determination of the peel strength the PSA strip specimens for investigation are laminated over the entire area of one side with a 23 μm PET film (Hostaphan RN 25; Mitsubishi Chemicals, for example) without air bubbles. After this has been done the second adhesive sheet strip side is covered at one end with a film strip (again Hostaphan RN 25) about 6 mm long, thereby forming at this end a nonadhesive grip tab region on both sides. Thereafter the adhesive sheet strip under test is bonded by its front side, using gentle finger pressure, to the test substrate (coated woodchip wallpaper: wallpaper=Erfurt Körning 52, color=Herbol Zenit LG, wallpaper bonded to compressed chipboard). The PSA samples are then pressed for 10 seconds at an applied pressure of 90 N per 10 cm² of bond area and thereafter are conditioned at 40° C. for 15 minutes. The test plates are then fixed horizontally so that the adhesive strip is pointing downward. Using a clamp (20 g), a 50 g weight is fastened to the nonadhesive grip tab, so that the resulting peel load (approximately 0.7 N per 20 mm of adhesive strip width) acts orthogonally to the bond plane. After a test phase of 15 minutes, and a repeat after 24 hours, a mark is made at the distance over which the adhesive strip has peeled away from the bond substrate since the beginning of the test. The distance between the two marks is recorded as the peel path (unit: mm per 24 hours).

### Tip-shear Strength

For the determination of the tip-shear strength the adhesive sheet under test, measuring 20 mm×50 mm and provided at one end on both sides with a nonadhesive grip tab region (obtained by laminating on a 25 μm biaxially oriented polyester film measuring 20 mm×13 mm (Hostaphan RN 25)), is bonded to the center of a highly polished square steel plate measuring 40 mm long×40 mm wide×3 mm thick. On its back the steel plate is provided centrally with a 10 cm steel rod which sits vertically on the surface of the plate. The test specimens obtained are bonded to the test substrate (steel) with a force of 100 N, with a press-on time of 5 seconds, and are left in the unloaded state for 5 minutes. After the chosen tip-shear load has been applied by attaching a suspended weight (20 N in the case of a 50 mm lever arm) a measurement is made of the time which elapses until the bond fails (i.e., tip-shear stability time). The test conditions are 23° C. with a relative humidity of 50%.

### Tip-shear Strength (Tip-shear Stability Times) Under Moisture Conditions

The measurement of the tip-shear strength under the influence of moisture is made as described above with the exception that the measurement is conducted at a relative humidity of 85% below a temperature of 35° C. The test substrates used are sheets of window glass 4 mm thick, cleaned beforehand with ethyl acetate and ethanol. Adhesive bonding and sample preparation is identical with the determination of the tip-shear strength under standard conditions. The load used is a weight of 10 N with a lever of 50 mm.

### Peel Strength Under Moisture Conditions

The measurement of the peel strength under the influence of moisture is made as described above for peel strength with the exception that the measurement is conducted at a relative humidity of 85% and at a temperature of 35° C. The test substrates used are sheets of window glass 4 mm thick, cleaned beforehand with ethyl acetate and ethanol. Adhesive bonding and sample preparation is identical with the determination of the peel strength under standard conditions. The load is 70 g. The peel path is determined in mm/24 h.

### Production of the Test Specimens

### Production of the PSA Strips

Pressure sensitive adhesives are processed to a homogeneous mixture in a heatable compounder with sigma blades (Werner & Pfleiderer LUK 1,0 K3 equipped with an LTH 303 thermostat from mgw LAUDA) at a temperature of about 160 to 180° C. under CO₂ as inertizing gas. After cooling, the adhesive is extruded for about 10 minutes at from 120 to 140° C. (temperature-controllable press: model KHL 50 from Bucher-Guyer) to produce single-layer adhesive sheet sections 700 μm thick (50 μm (average value (2-fold standard deviation). Single-layer PSA strips of the desired dimensions are obtained by die-cutting. Where multilayer PSA strips are produced the corresponding layers are joined beforehand by laminating (hot laminating where appropriate) and subsequently the adhesive strips are individualized by die-cutting.

1. A pressure sensitive adhesive for single-sided or double-sided adhesive sheet strips which are redetachable from substrates without residue or destruction by extensive stretching in the plane of the bond, composed of a mixture comprising a block copolymer and a tackifier, wherein at least one compound which is swellable in H₂O is incorporated into the mixture.

2. The pressure sensitive adhesive as claimed in claim 1, wherein said at least one compound which is swellable in H₂O is a superabsorbent.

3. The pressure sensitive adhesive as claimed in claim 1 or 2, wherein said at least one swellable compound is present in an amount of from 0.5 to 20% by weight, based on the weight of adhesive.

4. The pressure sensitive adhesive as claimed in claim 3, wherein said at least one swellable compound is present in an amount of from 2 to 8% by weight, based on the weight of adhesive.

5. The pressure sensitive adhesive as claimed in claim 1 or 2, wherein said at least one swellable compound is a mixture of two or more swellable compounds.

6. The pressure sensitive adhesive as claimed in claim 2, wherein said superabsorbent is a sodium salt of a crosslinked polyacrylic acid, a starch-modified crosslinked polyacrylic acid, a crosslinked polyacrylamide, a crosslinked polysulfonic acid or carboxymethylcellulose.

7. The pressure sensitive adhesive as claimed in claim 1, further comprising at least one additive.

8. A single-sided or double-sided adhesive sheet strip comprising the pressure sensitive adhesive of claim 1.

9. The pressure sensitive adhesive as claimed in claim 5, wherein said superabsorbent is a sodium salt of a crosslinked polyacrylic acid, a starch-modified crosslinked polyacrylic acid, a crosslinked polyacrylamide, a crosslinked polysulfonic acid or carboxymethylcellulose.
